(19) United States
(12) Patent Application Publication
(10) Pub. No.: US 2011/0044040 A1
(43) Pub. Date: Feb. 24, 2011

(54) LIGHTING DEVICE AND MANUFACTURING METHOD THEREOF

(76) Inventor: WEN-CHUNG CHIN, Kweishan Hsiang (TW)

Correspondence Address: LEONG C. LEI, PMB # 1008, 1839 YGNACIO VALLEY ROAD, WALNUT CREEK, CA, 94598, US

(21) Appl. No.: 12/543,520

(22) Filed: Aug. 19, 2009

(51) Int. Cl. F21S 4/00; F21V 21/00; H01J 9/24

(52) U.S. Cl. 362/249.02; 362/249.01; 445/23

(57) ABSTRACT

A lighting device includes a printed circuit board, a plurality of electrical connection units, and a plurality of illuminant units. The printed circuit board has a layer of insulation and a layer of circuit. The insulation layer forms a plurality of holes corresponding to a plurality of electrically conductive zones of the circuit layer. The electrical connection units are connected to the electrically conductive zones through the holes. The illuminant units are set in electrical connection with the electrical connection units. The electrical connection units are fixedly mounted to the circuit layer and electrical power is supplied through the electrically conductive zones to the illuminant units. The electrical connection units are arranged in an array on the printed circuit board.

### (a) TECHNICAL FIELD OF THE INVENTION

The present invention generally relates to a lighting device and a manufacturing method thereof, and more particularly to a manufacturing method or a structure of a lighting device that comprises a printed circuit board on which a plurality of electrical connection units is mounted to respectively connect a plurality of illuminant units in a non-destructive manner so as to safely install the illuminant units on the printed circuit board.

### (b) DESCRIPTION OF THE PRIOR ART

FIG. 1 of the attached drawings shows a conventional structure of a lighting device 1, which comprises a plurality of light-emitting diodes 5 that is directly soldered to a printed circuit board 7 so that the light-emitting diodes 5 each have electrical terminals that form solder spots 9 on the printed circuit board 7.

However, directly soldering the light-emitting diodes 5 to the printed circuit board may have the illuminant units directly contacting solders when the electrical terminals of the light-emitting diodes 5 are subjected to reflowing, leading to damage to plastic parts of the illuminant units due to excessively high temperature, severe environment in the reflowing oven, noise induced in the surroundings, electrostatic interference, and soldering flux and also damage caused by high temperature, temperature difference, and static electricity induced by soldering irons that are used for finishing of soldered surfaces after the reflowing process.

### SUMMARY OF THE INVENTION

An objective of the present invention is to provide a lighting device, which comprises a printed circuit board defining a plurality of holes to which a plurality of electrical connection units is respectively mounted for connection with a plurality of illuminant units.

Another objective of the present invention is to provide a lighting device, which comprises a plurality of protector units arranged to encompass a plurality of electrical connection units to isolate electrical coupling between the electrical connection units.

A further objective of the present invention is to provide a manufacturing method of a lighting device, which comprises a step of forming a plurality of electrical connection units on a printed circuit board for installation of a plurality of illuminant units.

To achieve the above objectives, in accordance with the present invention, a lighting device is provided, comprising a printed circuit board, a plurality of electrical connection units, and a plurality of illuminant units. The printed circuit board has a layer of insulation and a layer of circuit. The insulation layer forms a plurality of holes corresponding to a plurality of electrically conductive zones of the circuit layer. The electrical connection units are connected to the electrically conductive zones through the holes. The illuminant units are set in electrical connection with the electrical connection units. The electrical connection units are fixedly mounted to the circuit layer and electrical power is supplied through the electrically conductive zones to the illuminant units. The electrical connection units are arranged in an array on the printed circuit board.

To further achieve the above objectives, the present invention provides a method for manufacturing a lighting device, comprising the following steps: (i) providing a substrate; (ii) laying a plurality of electrically conductive zones on the substrate to form a circuit layer; (iii) forming a layer of insulation on the circuit layer; (iv) forming a plurality of holes in the insulation layer to correspond to the electrically conductive zones; (v) setting a plurality of electrical connection units in the holes to be in electrical connection with the electrically conductive zones; and (vi) electrically connecting a plurality of illuminant units to the electrical connection units.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional lighting device.

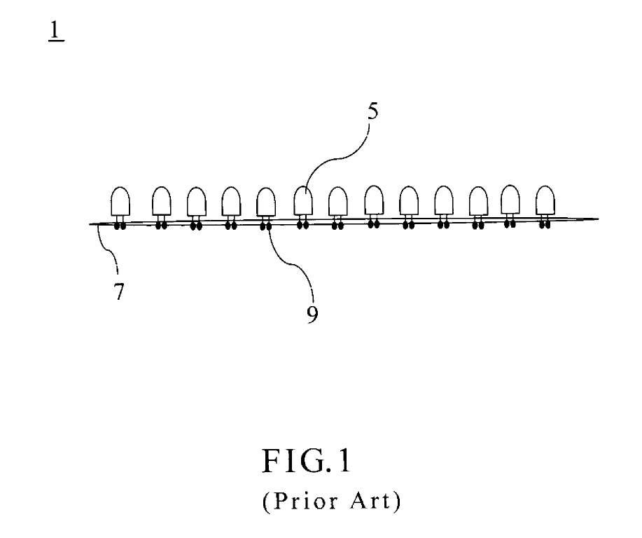

FIG. 2 is a top plan view showing a lighting device constructed in accordance with a preferred embodiment of the present invention.

FIG. 3 is a side elevational view of the lighting device of the preferred embodiment of the present invention.

FIG. 4 is a bottom view of the lighting device of the preferred embodiment of the present invention.

FIG. 5 is a schematic view showing a lighting device in accordance with an embodiment of the present invention.

FIG. 6 is a schematic view showing a lighting device in accordance with an embodiment of the present invention.

FIG. 7 is a schematic view showing a lighting device in accordance with an embodiment of the present invention.

FIG. 8 shows a flow chart of a method for manufacturing a lighting device in accordance with a preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

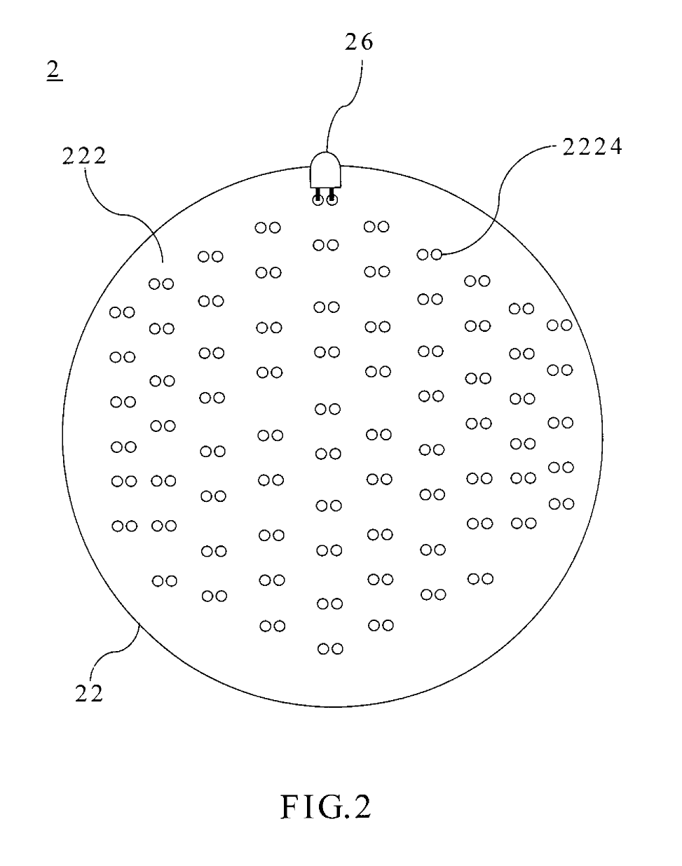

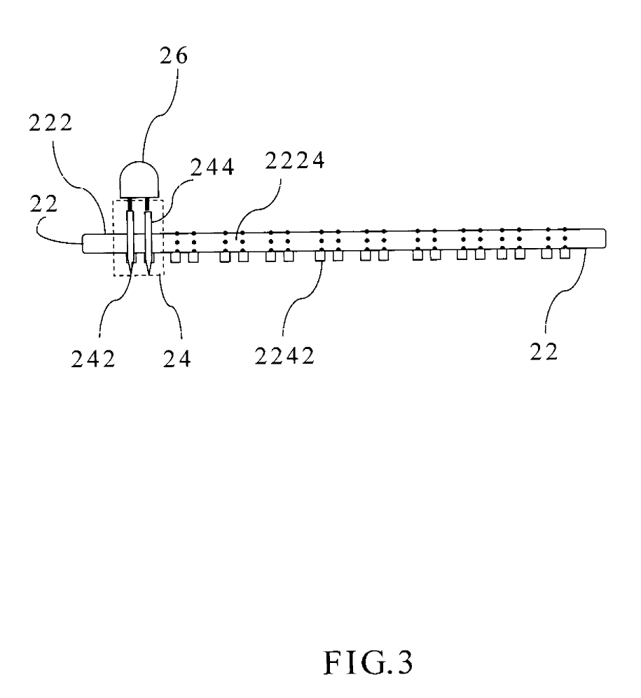

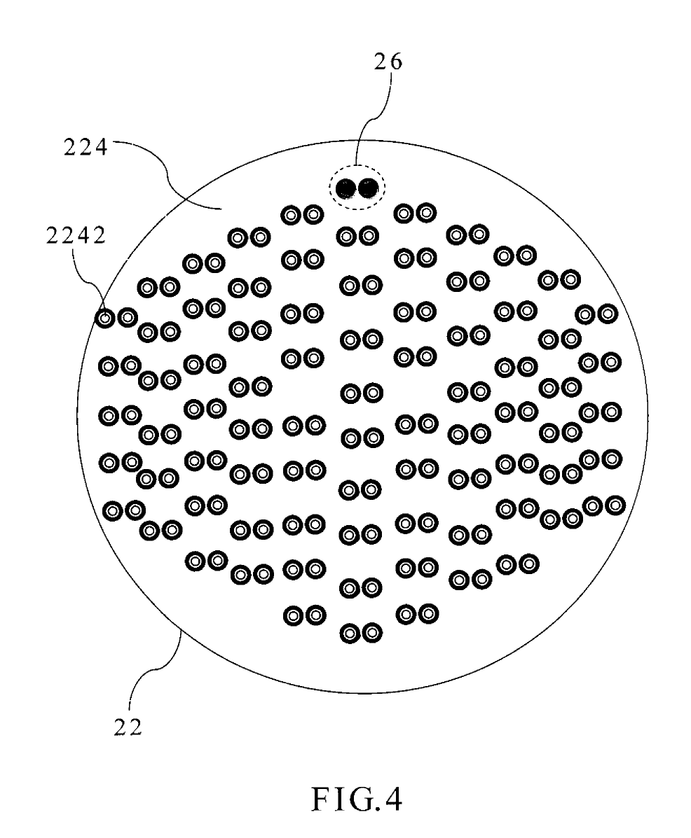

Referring to FIGS. 2 to 4, a top plan view, a side elevational view, and a bottom view of a lighting device in accordance with an embodiment of the present invention are shown. In the instant embodiment, the lighting device, which is generally designated at 2, comprises a printed circuit board 22, a plurality of electrical connection units 24, and a plurality of illuminant or light-emission units 26. The printed circuit board 22 comprises a layer 222 of insulation and a layer 224 of circuit. The insulation layer 222 forms a plurality of holes 2224, which respectively corresponds to a plurality of electrically conductive zones 2242 formed in the circuit layer 224. The electrical connection units 24 are connected to the electrically conductive zones 2242 via the holes 2224. The electrical connection units 24 each have two electrical connection terminals 242 and two illuminant connection terminals 244. The two electrical connection terminals 242 are fixed to the printed circuit board 22, and the two illuminant connection terminals 244 are arranged to correspond to the two electrical connection terminals 242. Further, the material that makes the electrical connection units 24 is metals. The electrical connection units 24 are fixedly connected to the circuit layer 224. Electrical power is selectively supplied through the electrically conductive zones 2242 to the electrical connection units 24. The electrical connection units 24 are arranged in an array on the printed circuit board 22. The illuminant units 26 are electrically connected to the electrical connection units 24. Here, a single illuminant unit 26 will be taken as an example for further description.

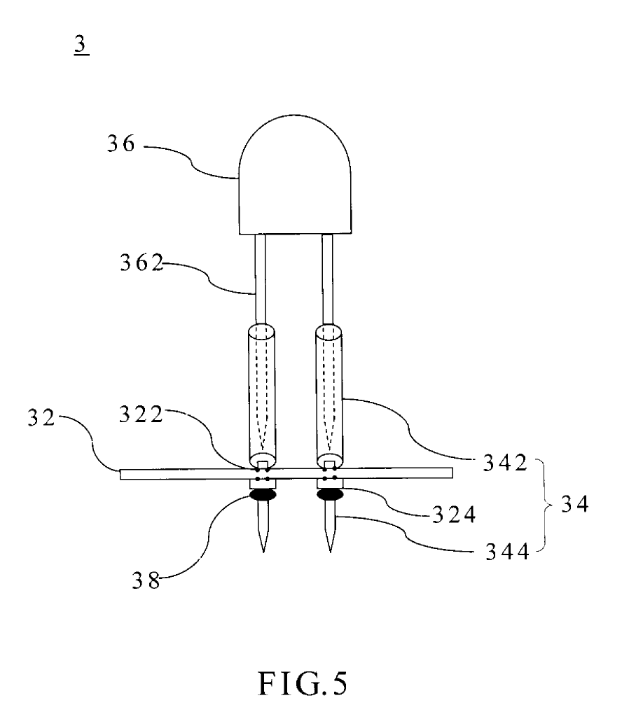

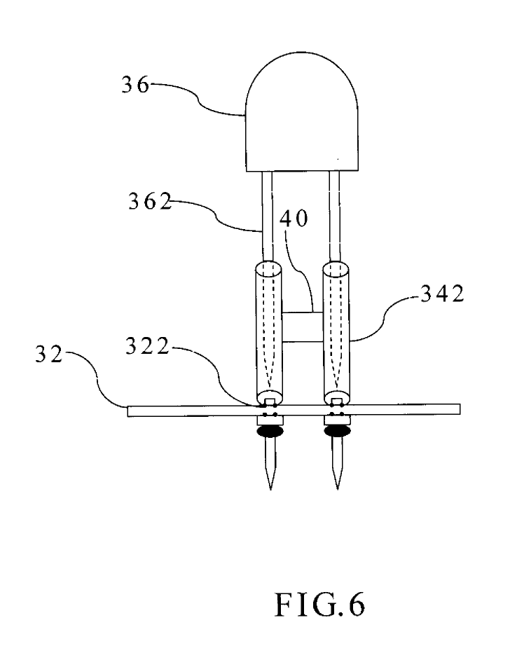

Referring to FIG. 5, which shows a schematic view of a lighting device in accordance with an embodiment of the present invention, in the embodiment illustrated, a lighting device 3 comprises a printed circuit board 32, an electrical connection unit 34, and an illuminant unit 36. The illuminant unit 36 may comprise a light-emitting diode having two electrical connection terminals 362 for electrical connection with two illuminant connection terminals 342 of the electrical connection unit 34. Further, the electrical connection unit 34 has two electrical connection terminals 344 each extending through a hole 322 to an electrically conductive zone 324 set on an opposite surface of the printed circuit board 32, and a retention unit 38 is employed to secure the electrical connection terminal 344 in position on the printed circuit board 32. For example, the retention unit 38 may comprise a metallic material including tin based material that is used for soldering purposes. Further, referring to FIG. 6, an insulation coupling unit 40 is selectively set between the two illuminant connection terminals 342, whereby the two illuminant connection terminals 342, before set on the printed circuit board 32, can be placed at the same spacing distance as that between the two electrical connection terminals 362 of the illuminant unit 36 in order to facilitate mounting thereof to the hole 322 in the course of assembling.

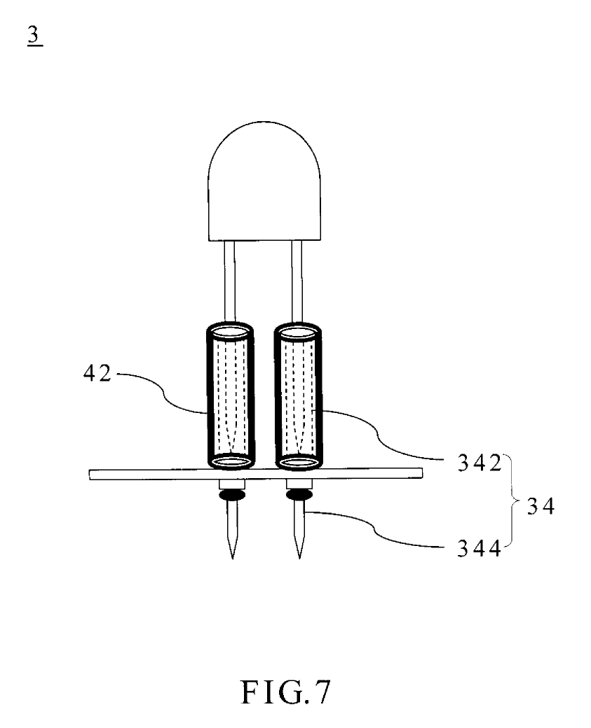

It is noted that the lighting device 3 may further comprise a protector unit 42, which encompasses each of the two illuminant connection terminals 342 of the electrical connection unit 34, as shown in FIG. 7, in order to isolate electrical coupling between adjacent electrical connection units 34. For example, the material that makes the protector unit 42 is an electrical insulation substance and/or plastics.

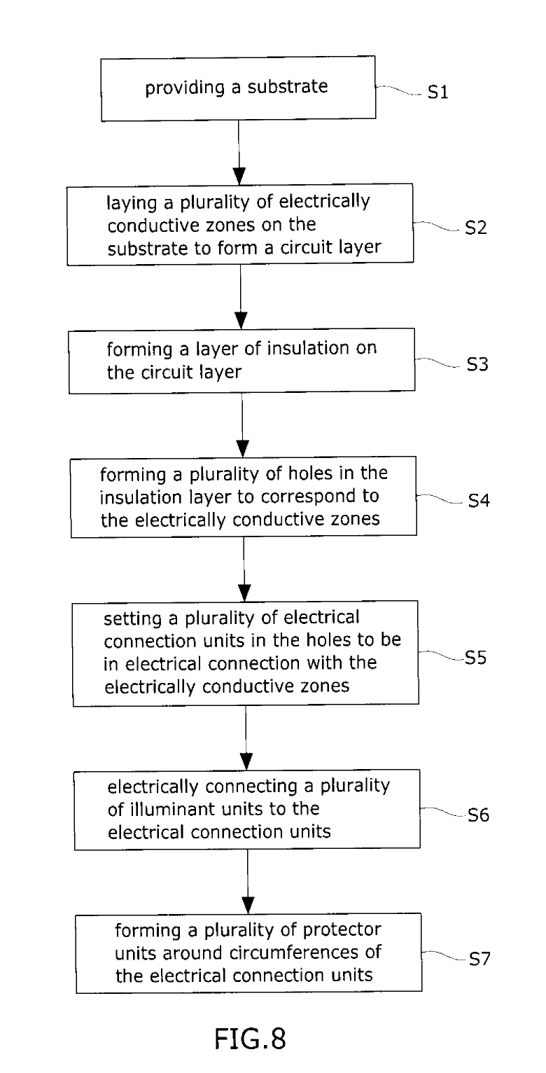

Referring to FIG. 8, which shows a flow chart of a method for manufacturing a lighting device in accordance with an embodiment of the present invention, in the instant embodiment, the manufacturing of the lighting device comprises a process starting with Step S1, in which a substrate is provided; followed by Step S2, in which a plurality of electrically conductive zones is laid on the substrate to form a circuit layer; followed by Step S3, in which a layer of insulation is formed on the circuit layer; further followed by Step S4, in which a plurality of holes is formed in the insulation layer to correspond to the electrically conductive zones; then followed by Step S5, in which a plurality of electrical connection units is respectively set in the holes to get in electrical connection with the electrically conductive zones; and finally followed by Step S6, in which a plurality of illuminant units is respectively and electrically connected to the electrical connection units. The process may further comprise Step S7, in which a plurality of protector units is formed to respectively encompass circumferences of the electrical connection units.

As described above, the present invention, when put into practice, offers the following advantage:

The present invention provides a method for manufacturing a lighting device, which, when subjected to reflowing, can prevent the illuminant unit from directly contacting the molten solder and thus eliminates potential risks of damages caused to plastic parts of the illuminant unit due to excessively high temperature, severe environment in the reflowing oven, noise induced in the surroundings, electrostatic interference, and soldering flux and also damages caused by high temperature, temperature difference, and static electricity induced by soldering irons that are used for finishing of soldered surfaces after the reflowing process.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lighting device, comprising:
a printed circuit board, which comprises a layer of insulation and a layer of circuit, the insulation layer forming a plurality of holes corresponding to a plurality of electrically conductive zones formed on the circuit layer;
a plurality of electrical connection units, which is connected to the electrically conductive zones through the holes; and
a plurality of illuminant units, which is electrically connected to the electrical connection units;
wherein the electrical connection units are fixedly mounted to the circuit layer and electrical power is supplied to the illuminate units through the electrically conductive zones, the electrical connection units being arranged in an array on the printed circuit board.

2. The lighting device according to claim 1 further comprising a plurality of protector units encompassing the electrical connection units to isolate electrical coupling between the electrical connection units.

3. The lighting device according to claim 1, wherein the electrical connection units each comprise two electrical connection terminals and two illuminant connection terminals, the two electrical connection terminals being fixedly connected to the circuit layer, the two illuminant connection terminals being set to correspond to the two electrical connection terminals and electrically connected to the illuminant units.

4. The lighting device according to claim 1, wherein the electrical connection units are made of metal.

5. The lighting device according to claim 1, wherein the illuminant units comprise light-emitting diodes.

6. The lighting device according to claim 2, wherein the protector units are made of an electrical insulation substance.

7. The lighting device according to claim 6, wherein the protector units are made of plastics.

8. A method for manufacturing a lighting device, comprising the following steps:
(i) providing a substrate;
(ii) laying a plurality of electrically conductive zones on the substrate to form a circuit layer;
(iii) forming a layer of insulation on the circuit layer;
(iv) forming a plurality of holes in the insulation layer to correspond to the electrically conductive zones;
(v) setting a plurality of electrical connection units in the holes to be in electrical connection with the electrically conductive zones; and
(vi) electrically connecting a plurality of illuminant units to the electrical connection units.

9. The method according to claim 8 further comprising the following step:
forming a plurality of protector units around circumferences of the electrical connection units.

10. The method according to claim 8, wherein the electrical connection units each comprise two electrical connection terminals and two illuminant connection terminals, the two electrical connection terminals being fixedly connected to the circuit layer, the two illuminant connection terminals being set to correspond to the two electrical connection terminals and electrically connected to the illuminant units.

11. The method according to claim 8, wherein the electrical connection units are made of metal.

12. The method according to claim 8, wherein the illuminant units comprise light-emitting diodes.

13. The method according to claim 9, wherein the protector units are made of an electrical insulation substance.

14. The method according to claim 13, wherein the protector units are made of plastics.
